(19) United States
(12) Patent Application Publication
(10) Pub. No.: US 2003/0014438 A1
(43) Pub. Date: Jan. 16, 2003

(54) Internal data structure for an application intended to interface with an interface for an HTML or XML-type document

(76) Inventor: Sylvain Devillers, Paris (FR)

Correspondence Address: Corporate Patent Counsel, U.S. Philips Corporation, 580 White Plains Road, Tarrytown, NY, 10591, US

(21) Appl. No.: 10/128,641

(22) Filed: Apr. 23, 2002

(30) Foreign Application Priority Data
Apr. 27, 2001 (FR) 0105767

(51) Int. Cl. G06F 17/00

(52) U.S. Cl. 707/512

(57) ABSTRACT

The invention proposes an internal data structure, written in an object programming language, and which is intended to be instantiated for providing an internal data representation able to be manipulated by an application program. This internal data structure has an abstract generic class, and other classes that all inherit from said abstract generic class. This abstract generic class contains a generic method of writing a node in an interface for an HTML or XML-type document, and/or a generic method of reading a node of an interface associated with an HTML or XML-type document.

Thus, the application is capable in input mode of generating an internal representation from an interface associated with an HTML or XML-type document by instantiation of said internal data structure, and of writing an interface for an HTML or XML-type document in output mode, from an internal data representation.

The invention relates to an internal data structure written in an object programming language, having a plurality of classes intended to be instantiated, for generating an internal representation of an HTML or XML-type document belonging to a family of documents, by reading an interface associated with said document and consisting of a tree of nodes.

The invention also relates to a method of instantiating such an internal data structure from an interface associated with an HTML or XML-type document, belonging to a certain family of documents.

The invention also relates to an item of electronic equipment having means of implementing such an instantiation method.

The invention also relates to a program having instructions making it possible to implement such an instantiation method, when said program is executed by a processor.

The invention also relates to an internal data structure written in an object programming language, having a plurality of classes intended to be instantiated for generating an internal data representation able to be manipulated by an application program that is itself intended to write an interface for an HTML or XML-type document belonging to a family of documents, said interface consisting of a tree of nodes.

The invention also relates to a method of writing an interface for an HTML or XML-type document belonging to a certain family of documents, from an internal data representation that is an instance of such an internal data structure.

The invention also relates to an item of electronic equipment having means of implementing such a writing method.

The invention also relates to a program having instructions making it possible to implement such a writing method, when said program is executed by a processor.

The invention has important applications in the field of data structuring and manipulation of previously structured data. It applies advantageously in the context of the Internet, for example to mobile communication equipment, or to television equipment.

An interface for an HTML or XML-type document is for example defined in the specification “Document Object Model (DOM), level 1 specification, version 1.0, Oct. 1, 1998” defined by the W3C consortium. This specification defines an object-oriented tree structure, referred to as DOM, making it possible to model an HTML or XML-type document. The nodes of this tree structure represent objects that have an identity and functions (in object programming, such functions, which are attached to objects, are called methods). The methods defined in the DOM specification make it possible to navigate in the DOM structure and manipulate it (access to a node, modification, deletion, addition of a node, etc.).

The DOM structure was proposed to serve as an interface between an HTML or XML-type document and an application that needs to access the content of said document, and/or has to generate such a document.

However, the DOM structure is difficult to manipulate. In general, rather than manipulate the DOM interface directly, applications manipulate an internal data representation instantiated from an internal data structure belonging to them.

These applications can use, in input mode, a DOM interface for retrieving the content of an HTML or XML-type document necessary for the instantiation of an internal data representation.

Conversely, in output mode, they can generate a DOM interface from an internal data representation, in order to then make it possible to produce an HTML or XML-type document.

The aim of the invention is notably to propose a particularly advantageous internal data structure. In a first embodiment, an internal data structure according to the invention has a plurality of classes intended to be instantiated, for generating an internal representation of an HTML or XML-type document belonging to a family of documents, by reading an interface associated with said document and consisting of a tree of nodes, and is characterized in that it has:

a generic class that contains at least one generic method of reading a node of such an interface, in order to fill an object that is an instance of a class of said internal data structure,

one or more classes that inherit from said generic class and obey naming and correspondence rules established with respect to said family of documents, said naming and correspondence rules being used by said generic reading method for reading said interface.

In a second embodiment, an internal data structure has a plurality of classes intended to be instantiated for generating an internal data representation that can be manipulated by an application program that is itself intended to write an interface for an HTML or XML-type document belonging to a family of documents, and is characterized in that it has:

a generic class that contains a generic method of writing a node in such an interface, from an instance of a class of said internal data structure,

one or more classes that inherit from said generic class and obey naming and correspondence rules established with respect to said family of documents, said naming and correspondence rules being used by said generic writing method for writing said interface.

Advantageously, said generic class has both a generic method of reading a node of such an interface in order to fill an object that is an instance of a class of said internal data structure, and a generic method of writing a node in such an interface, from an instance of a class of said internal data structure.

Thus, the invention defines an abstract generic class from which all the other classes inherit, this abstract generic class containing a generic method of writing a node in an interface for an HTML or XML-type document, and/or a generic method of reading a node of an interface associated with an HTML or XML-type document.

The inheritance mechanism is a conventional mechanism of object programming languages. It allows in particular a class to implicitly contain the methods that are defined in the class from which it inherits. The invention therefore makes it possible to define a single writing method and/or a single reading method that are generic methods applicable to any node whatsoever of an interface, at the level of a class that is an abstract class. The objects of the internal data representation are instances of classes that inherit from this abstract class so that they all contain said reading and/or writing methods, by inheritance.

The writing of the internal data structure is thus considerably simplified.

In one particularly simple embodiment of the invention, said HTML or XML-type documents have one or more elements that have one or more subelements and/or one or more attributes and/or some content, and said class or classes have one or more instance variables and obey the following naming and correspondence rules:

a class of said internal structure corresponds to an element of an HTML or XML-type document, said class and said element having the same name,

and in said class:

an instance variable having a reserved name corresponds to the content of said element,

an instance variable constituted by an object that is an instance of a class inheriting from the generic class corresponds to a subelement of said element, said subelement and the class of which the object is an instance having the same name,

an instance variable constituted by an array of objects that are instances of a class inheriting from the generic class corresponds to a list of subelements of said element, said subelements and the class of which the objects are instances having the same name,

the other instance variables correspond to attributes of said element, an attribute and the instance variable to which it corresponds having the same name.

Another aim of the invention is to propose a method of writing an interface for an HTML or XML-type document from an internal data representation that is an instance of such an internal data structure. Said writing method consists of scanning said internal data representation object by object, and applying said generic writing method to each object of said representation.

Another aim of the invention is to propose a method of instantiating an internal data structure from an interface associated with an HTML or XML-type document, in order to generate an internal representation of said document. Said instantiation method consists of scanning said internal data structure class by class, in order to instantiate said classes, by applying said generic reading method to each instantiated object.

The invention will be further described with reference to examples of embodiments shown in the drawings to which, however, the invention is not restricted.

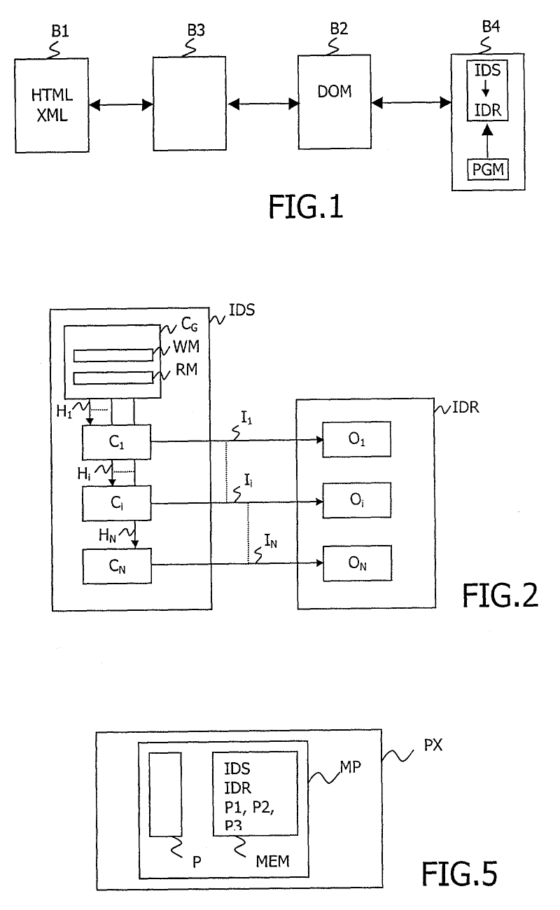

FIG. 1 is a block diagram depicting an example of interfacing between an HTML or XML-type document and an application,

FIG. 2 is a schematic representation of an internal data structure according to the invention,

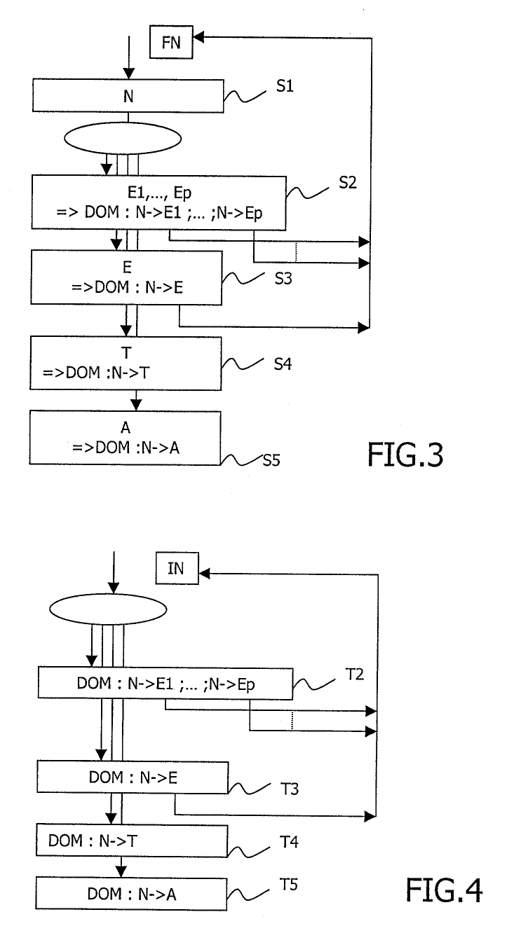

FIG. 3 is a block diagram of a flow diagram of a generic writing method according to the invention,

FIG. 4 is a block diagram of a flow diagram of a generic reading method according to the invention,

FIG. 5 is a diagram of an example item of equipment according to the invention.

FIG. 1 is a diagram having four blocks B1 to B4 and depicting an example of interfacing between an HTML or XML-type document and an application. The block B1 represents an HTML or XML-type document. The block B2 represents an interface for an HTML or XML-type document. This interface is for example constituted by a structure conforming to the DOM specification. The block B3 represents a syntax analyzer that makes it possible to read an HTML or XML-type document in order to generate an interface for said HTML or XML-type document. Conversely, the syntax analyzer also makes it possible to generate an HTML or XML-type document from an interface for an HTML or XML-type document.

The block B4 represents an application that contains an internal data structure IDS and at least one application program PGM intended to manipulate an internal data representation IDR that is an instance of the internal data structure IDS.

The internal data structure IDS describes the characteristics of a certain family of HTML or XML-type documents (the documents that form part of the same family meet a certain number of constraints that can be expressed in a document model, for example a “DTD” in the XML language, or a “schema” in the XML-schema language; the internal data structure describes these constraints).

The internal data structure is provided to make it possible to retrieve the content of an HTML or XML-type document belonging to said family, from an interface associated with said HTML or XML-type document, upon instantiation of an internal data representation IDR. It is also provided to make it possible to generate in output mode an interface for an HTML or XML-type document belonging to said family, from an internal data representation.

By way of example, the document represented by the block B1 can be an XML document representing a file in the JPEG 2000 format. In this case, the structure IDS is a description of said JPEG 2000 format. Upon instantiation of this internal data structure, the content of the JPEG 2000 file is retrieved from the DOM interface associated with the XML document that represents said JPEG 2000 file.

FIG. 2 depicts schematically a preferential example of an internal data structure IDS and an internal data representation IDR that is an instance of this internal data structure IDS.

The internal data structure IDS is written in an object programming language such as C++ or JAVA. It has a generic abstract class C_{G} that contains a generic writing method WM and a generic reading method RM. It also has a plurality of classes C₁, . . . Cᵢ, . . . , C_{N} that inherit from the generic class C_{G}. In FIG. 2, these inheritance relationships are represented by arrows H₁, . . . Hᵢ, . . . , H_{N}.

The internal data representation IDR has a plurality of objects O₁, . . . Oᵢ, O_{N} that are instances of the classes C₁, . . . Cᵢ, . . . , C_{N}. The instantiation of the objects O₁, . . . Oᵢ, . . . , O_{N} is symbolized by arrows I₁, . . . Iᵢ, . . . , I_{N}. Since the objects O₁, . . . Oᵢ, . . . , O_{N} are instances of classes that inherit from the abstract generic class C_{G}, they contain the writing method WM and reading method RM that are defined in the generic class C_{G}.

In accordance with the invention, the classes C₁, . . . Cᵢ, . . . , C_{N} obey naming and correspondence rules established with respect to said family of documents. These naming and correspondence rules are used by the generic writing and reading methods WM and RM for writing and reading an interface for said HTML or XML-type document.

Generally speaking, an HTML or XML-type document has one or more elements that have one or more subelements and/or one or more attributes and/or some content.

Furthermore, in object programming, a class is capable of having one or more instance variables, each instance variable having a name and a type. In the remainder of the description, four categories of instance variable will be considered:

instance variables of character string type having a reserved name (in the remainder of the description this reserved name is “data”),

instance variables of object type,

instance variables of object array type,

other instance variables having a primitive type, for example instance variables of integer type, of floating type or of character string type having a name different from said reserved name.

In an advantageous embodiment of the invention, the classes of the internal data structure obey the following naming and correspondence rules:

each class of said internal structure corresponds to one element of an HTML or XML-type document, said class and said element having the same name,

and in said class:

an instance variable of character string type, having said reserved name, corresponds to the content of said element,

an instance variable constituted by an object that is an instance of a class inheriting from the generic class corresponds to a subelement of said element, said subelement and the class of which the object is an instance having the same name,

an instance variable constituted by an array of objects that are instances of a class inheriting from the generic class corresponds to a list of subelements of said element, said subelements and the class of which the objects are instances having the same name,

the other instance variables correspond to attributes of said element, an attribute and the instance variable to which it corresponds having the same name.

The naming and correspondence rules that have just been stated will now be illustrated by giving an example of an XML document, and describing the classes of an internal data structure intended to be instantiated in order to generate an internal representation of such a document:

Example of an XML document:

<Mainheader>
<SIZ Csiz=”3”>

this is some content

</SIZ>
</Mainheader>

The corresponding internal data structure has two classes that inherit from the generic class: the class “SIZ” and the class “Mainheader”. The class “SIZ” has an instance variable of integer type that has the name “Csiz”, and an instance variable of character string type that has the name “data”. The class “Mainheader” has an instance variable that is an object that is an instance of the class “SIZ” and has the name “siz”.

In the JAVA language, these two classes are written as follows (the generic class here has the name JElt:

public class SIZ

extends JElt {
public int Csiz;
public String data;
}

public class Mainheader

extends JElt{
public SIZ siz;

}

In accordance with the DOM specification, a DOM tree is capable of having different types of node and notably element type nodes, attribute type nodes, and text type nodes. An element type node corresponds to an element of an HTML or XML document, an attribute type node corresponds to an attribute of an HTML or XML document, and a text type node corresponds to content of an element of an HTML or XML document.

FIG. 3 depicts a flow diagram of a generic method of writing a node in a DOM interface. Such a method uses as an argument the DOM node that is the father of the node to be written (in FIG. 3, this node is denoted FN). It is intended to be applied by an object, referred to as the current object.

According to FIG. 3, a generic writing method according to the invention has a first step S1 that has the aim of creating an element type node N and naming it according to the name of the class of the current object. The method next consists of scanning all the instance variables of the current object and executing, for each instance variable, one of the following steps according to the type of the instance variable:

if the instance variable is an array of objects that are instances of a class that inherits from the generic class JElt (step S2):

creation of a list L of DOM element type nodes E1, . . . , Ep, named according to the name of said class,

addition of the nodes in this list to the DOM tree, as child nodes of the current node N,

calling of the writing method for each node E, . . . , Ep thus added.

if the instance variable is an object that is an instance of a class that inherits from the generic class JElt (step S3):

creation of a DOM element type node E, named according to the name of said class,

addition of the created node E to the DOM tree, as a child node of the current node N,

calling of the writing method for the node E thus added.

if the instance variable is an instance variable of character string type, having the reserved name “data” (step S4):

creation of a DOM text type node T whose value is constituted by the value of the instance variable.

in all other cases (step S5):

creation of a DOM attribute type node A, named according to the name of the instance variable, and whose value is constituted by the value of the instance variable.

FIG. 4 depicts a flow diagram of a generic method of reading a node in a DOM interface. Such a method uses as an argument the DOM node that contains the information to be retrieved in order to instantiate an object referred to as the current object (in FIG. 4 this node is denoted IN).

As shown in FIG. 4, a generic reading method according to the invention consists of scanning all the instance variables of the current object and executing, for each instance variable, one of the following steps according to the type of the instance variable:

if the instance variable is an array of objects that are instances of a class that inherits from the generic class JElt (step T2):

searching in the DOM tree for all DOM element type nodes that have the name of the class and are child nodes of the current node (in FIG. 4 these nodes are denoted E1, . . . , Ep),

calling of the reading method for each of these nodes E1, . . . , Ep.

if the instance variable is an object that is an instance of a class that inherits from the generic class JElt (step T3):

searching in the DOM tree for the DOM element type node that has the name of the class and is a child node of the current node (in FIG. 4 this node is denoted E),

calling of the reading method for this node E.

if the instance variable is an instance variable of character string type, having the reserved name “data” (step T4):

searching for a DOM text type node that is a child of the current DOM node (in FIG. 4 this node is denoted T),

retrieval of the value of this node T in order to fill the current instance variable.

in all other cases (step T5):

searching in the DOM tree for the DOM attribute type node that has the name of the current instance variable and is a child node of the current node (in FIG. 4 this node is denoted A),

retrieval of the value of this node A in order to fill the current instance variable.

The annex contains an example implementation, in the JAVA language, of a generic class “JElt” that has a generic writing method “writeToDOM”, and a generic reading method “readFromDOM”.

FIG. 5 depicts an example of an item of equipment according to the invention. This equipment PX has a microprocessor-based assembly MP that contains notably a processor P and memories MEM. The memories MEM contain:

an internal data structure IDS,

a program P1 for instantiating the internal data structure intended to generate an internal data representation IDR,

an application program P2 intended to manipulate an internal input data representation and to deliver an internal output data representation,

a program P3 for writing an interface from said output data representation.

An internal data structure has been described that has a generic class containing both a generic method of reading a node of an interface, and a generic method of writing a node in an interface. This is not limitative. The generic class can have only either one of these two methods.

Furthermore, in the embodiment just described, the interfaces are DOM interfaces and the documents are HTML or XML documents, since these are the interfaces and the documents that are most commonly used at the date of the invention. This is not restrictive either and the invention is in principle applicable to other types of interface, to other types of document, or to developments of this type of interface and document.

ANNEX
package XJJ.elts;
import java.util.*;
import java.lang.*;
import java.lang.reflect.*;
import org.w3c.dom.*;
import org.apache.xerces.dom.*;
public abstract class JElt

implements JEltInterface {

private String jeltClassName= “XJJ.elts.JElt”;
private Class jeltClass;
private static String CDATAName = “data”;

//---------------------------------------------------------------------------

public int writeToDOM(Node fatherNode) {

if (fatherNode == null) {

return(0);

}
// Get owner document
Document doc = fatherNode instanceof Document ?

(Document) fatherNode:
(Document) fatherNode.getOwnerDocument();

// Get this class name without all inheritance string
String thisName = getShortName(this.getClass().getName());
// Get JElt Class
jeltClass = getJEltClass();
// Create DOM element and add it to fatherNode
Element node = (Element) doc.createElement(thisName);
fatherNode.appendChild(node);
// Scan the fields and check whether they are attributes or subelements
Field [] myFields = this.getClass().getFields();
for (int i = 0; i < myFields.length; i++) {

Field field = myFields[i];
String fieldName = field.getName();
Object value = null;
try {

value = field.get(this);

}
catch (IllegalAccessException e) {

e.printStackTrace(System.err);
System.exit(0);

}
if (value != null) {

Class fieldClass = field.getType();

// case #1: current field is an array of JElt subclasses

if ((fieldClass.isArray()) &&

(jeltClass.isAssignableFrom(fieldClass.getComponentType()))) {
JElt [] array = (JElt []) value;
for (int j = 0; j <array.length; j++) {

// Run writeToDOM for each component of the array
if (array[j] != null) {

array[j].writeToDOM(node);

}
else {

System.out.println(“Warning: found null field”);

}

}

}

// case #2: current field is a single JElt subclass

else if (jeltClass.isAssignableFrom(fieldClass)) {

((JElt) value).writeToDOM(node);

}

// case #3: current field is named “data” and is a String = an XML text node

else if (CDATAName.compareTo(fieldName) == 0) {

if (!fieldClass.equals((new String()).getClass())) {

System.err.println(“Error: field ” + fieldName +

“ should be of type String”);

System.err.println(“Exit...”);
System.exit(0);

}
String textData = (String) value;
Text textNode = (Text) doc.createTextNode(textData);
node.appendChild(textNode);

}

// case #4: current field is a primitive type = actual attribute

else {

node.setAttribute(fieldName, value.toString());

}

} // end of if field != null

} // end of for each field
return(1);

}

//---------------------------------------------------------------------------

public int readFromDOM(Element node) {

| | Text textNode = null; |
|---|---|
| | int nTextNodes = 0; |
| | // Check that XML node name is the same as current object |
| | String nodeName = node.getNodeName(); |
| | String thisName = getShortName(this.getclass().getName()); |
| // | System.out.println(“readFromDOM: trying to instantiate a ” + thisName + |

| | |
|---|---|
| // | “ from the XML node ” + nodeName); |

if (thisName.compareTo(nodeName) != 0) {

System.err.println(“Error: XML node and object do not match”);
System.exit(0);

}
// Get JElt Class
jeltClass = getJEltClass();

// Scan the child nodes and fill a hashtable

| | |
|---|---|
| // | We maintain two hashtables: |

| | |
|---|---|
| // | ht containing the child nodes whose tag = fieldName |
| // | htn containing the number of child nodes whose tag = fieldName |

NodeList nodeList = node.getChildNodes();
Hashtable ht = new Hashtable();
Hashtable htn = new Hashtable();
if (nodeList == null) {

ht = null;

}
else {

// For each child node, fill ht and htn
for (int i = 0; i <nodeList.getLength(); i++) {

Node aNode = nodeList.item(i);
if (aNode.getNodeType() == Node.ELEMENT_NODE) {

Element childNode = (Element) aNode;
String childNodeName = childNode.getTagName();
int ind = htn.containsKey(childNodeName) ?

((Integer) htn.get(childNodeName)).intValue():
0;

ht.put(childNodeName + ind, childNode);
htn.put(childNodeName, new Integer(ind+1));

}
else if (aNode.getNodeType() == Node.TEXT_NODE) {

textNode = (Text) aNode;
nTextNodes++;

}

}

}
// Scan the class fields and instantiate them
// with corresponding attribute
Field [] myFields = this.getClass().getFields();
for (int i = 0; i < myFields.length; i++) {

Field field = myFields[i];
String fieldName = field.getName();
Class fieldClass = field.getType();
Object fieldValue = null;
try {

fieldValue = field.get(this);

}
catch (IllegalAccessException e) {

e.printStackTrace(System.err);
System.exit(0);

}

// case #1: current field is an array of JElt subclasses
// In this case, the child node name is the *** component class ***

if ((fieldClass.isArray()) &&

(jeltClass.isAssignableFrom(fieldClass.getComponentType()))) {
// Get the component class
// Try to find a child node with the same name
Class compClass = fieldClass.getComponentType();
String compClassName = getShortName(compClass.getName());
Object htnValue = htn.get(compClassName);
if (htnValue == null) {

if (fieldValue != null) {

System.err.println(“Null value in htn for key ”

+compClassName);

}

}
else {

int n = ((Integer) htnValue).intValue();
if (n < 1) {

System.err.println(“Could not find ” +

compClassName+ “ in DOM”);

System.exit(0);

}
// Allocate a new array of JElt objects for the field
JElt [] arr = null;
try {

arr = (JElt []) Array.newInstance(compClass, n);
for (int j = 0; j < n; j++) {

arr[j] = (JElt) compClass.newInstance();

}
field.set(this, arr);

}
catch (Exception e) {

e.printStackTrace(System.err);
System.exit(0);

}
// Instantiate each elt of the array
for (int j = 0; j < n; j++) {

Element childNode =

(Element) ht.get(compClassName + j);

if (childNode == null) {

System.err.println(“Error, could not find ”+

compClassName + j);

System.exit(0);

}
arr[j].readFromDOM(childNode);

}

}

}

// case #2: current field is a single JElt subclass
// In this case, the child node name is the *** field class ***

else if (jeltClass.isAssignableFrom(fieldClass)) {

String fieldClassName = getShortName(fieldClass.getName());
// Try to find a DOM node with the same name
Object htnValue = htn.get(fieldClassName);
// Is there an corresponding XML node ?
if (htnValue == null) {

| //System.out.println(“Warning: could not find XML node ” | |
|---|---|
| // | + fieldClassName); |

}
else {

// Allocate a new JElt object for the field
JElt childJElt = null;
try {

childJElt = (JElt) fieldClass.newInstance();
field.set(this, childJElt);

}
catch (Exception e) {

e.printStackTrace(System.err);
System.exit(0);

}
if (((Integer) htnValue).intValue() != 1) {

System.err.println(“Found more than one ”+

fieldClassName +“ in DOM”);

System.exit(0);

}
Element childNode = (Element) ht.get(fieldClassName + “0”);
childJElt.readFromDOM(childNode);

}

}

// case #3: current field is named “data” and is a String = an XML text node

else if ((CDATAName.compareTo(fieldName) == 0) &&

fieldClass.equals((new String()).getClass())) {

if ((nTextNodes == 1) || (textNode != null)) {

String textData = null;
try {

textData = textNode.getData();
field.set(this, textData);

}
catch (Exception e) {

e.printStackTrace(System.err);
System.exit(0);

}

}
else if (nTextNodes > 1) {

System.err.println(“Error: more than one text node in ”

+ nodeName);

System.exit(0);

}
else {

System.out.println(“Warning: could not find data for ” +

nodeName);

}

}

// case #4: current field is a primitive type = actual attribute
// In this case, the attribute name is the *** field name ***

else {

String strValue = node.getAttribute(fieldName);
if ((strValue == null) || (strValue.length() == 0)) {

System.err.println(“Could not find attribute ”+

fieldName);

}
else {

try {

if (fieldClass.equals(Integer.TYPE)) {

field.setInt(this, (new Integer(strValue)).intValue());

}
else if (fieldClass.equals(Short.TYPE)) {

field.setShort(this, (new Short(strValue)).shortValue());

}
else if (fieldClass.equals(Byte.TYPE)) {

field.setByte(this, (new Byte(strValue)).byteValue());

}
else if (fieldClass.equals(Boolean.TYPE)) {

field.setBoolean(this,

(new Boolean(strValue)).booleanValue());

}
else if (fieldClass.equals((new String()).getClass())) {

field.set(this, strValue);

}
else {

System.err.println(fieldClass.getName() +

“ : type not found”);

System.exit(0);

}

}
catch (Exception e) {

e.printStackTrace(System.err);
System.exit(0);

}

}

} // end of case #4

} // end of for each field
return(1);

}

//---------------------------------------------------------------------------

public Class getJEltClass() {

// Get JElt Class

Class myClass = null;
try {

myClass = Class.forName(jeltClassName);

}
catch (ClassNotFoundException e) {

System.err.println(“Class ” + jeltClassName + “ not found”);
System.exit(0);

}
return(myClass);

}

//---------------------------------------------------------------------------

public String getShortName(String jeltLongName) {

int k = jeltLongName.lastIndexOf(‘.’);
String jeltShortName = k != −1 ?

jeltLongName.substring(k + 1) :
jeltLongName;

return jeltShortName;

}

}

1. An internal data structure written in an object programming language, having a plurality of classes intended to be instantiated, for generating an internal representation of an HTML or XML-type document belonging to a family of documents, by reading an interface associated with said document said interface consisting of a tree of nodes, characterized in that said internal structure has:
a generic class that contains at least one generic method of reading a node of such an interface, in order to fill an object that is an instance of a class of said internal data structure,
one or more classes that inherit from said generic class and obey naming and correspondence rules established with respect to said family of documents, said naming and correspondence rules being used by said generic reading method for reading said interface.

2. An internal data structure written in an object programming language, having a plurality of classes intended to be instantiated for generating an internal data representation that can be manipulated by an application program that is itself intended to write an interface for an HTML or XML-type document belonging to a family of documents, said interface consisting of a tree of nodes, characterized in that said internal data structure has:
a generic class that contains a generic method of writing a node in such an interface, from an instance of a class of said internal data structure,
one or more classes that inherit from said generic class and obey naming and correspondence rules established with respect to said family of documents, said naming and correspondence rules being used by said generic writing method for writing said interface.

3. An internal data structure as claimed in one of claims 1 or 2, characterized in that said HTML or XML-type documents have one or more elements that have one or more subelements and/or one or more attributes and/or some content, and said class or classes have one or more instance variables and obey the following naming and correspondence rules:
a class of said internal structure corresponds to an element of an HTML or XML-type document, said class and said element having the same name,
and in said class:
an instance variable having a reserved name corresponds to the content of said element,
an instance variable constituted by an object that is an instance of a class inheriting from the generic class corresponds to a subelement of said element, said subelement and the class of which the object is an instance having the same name,
an instance variable constituted by an array of objects that are instances of a class inheriting from the generic class corresponds to a list of subelements of said element, said subelements and the class of which the objects are instances having the same name,
the other instance variables correspond to attributes of said element, an attribute and the instance variable to which it corresponds having the same name.

4. A method of writing an interface for an HTML or XML-type document from an internal data representation that is an instance of an internal data structure as claimed in claim 2, said writing method consisting of scanning said internal data representation object by object, and applying said generic writing method to each object of said representation.

5. A method of writing an interface for an HTML or XML-type document from an internal data representation that is an instance of an internal data structure as claimed in claim 3, said writing method consisting of scanning said internal data representation object by object, and applying said generic writing method to each object of said representation.

6. A program having instructions making it possible to implement a method as claimed in claim 4 for writing an interface for an HTML or XML-type document, when said program is executed by a processor.

7. An item of electronic equipment having means of implementing a method as claimed in claim 3 for writing an interface for an HTML or XML-type document.

8. A method of instantiating an internal data structure as claimed in claim 1 from an interface associated with an HTML or XML-type document, in order to generate an internal representation of said document, said instantiation method consisting of scanning said internal data structure class by class, in order to instantiate said classes, by applying said generic reading method to each instantiated object.

9. A method of instantiating an internal data structure as claimed in claim 3 from an interface associated with an HTML or XML-type document, in order to generate an internal representation of said document, said instantiation method consisting of scanning said internal data structure class by class, in order to instantiate said classes, by applying said generic reading method to each instantiated object.

10. A program having instructions making it possible to implement a method as claimed in claim 8 for instantiating an internal data representation, when said program is executed by a processor.

11. An item of electronic equipment having means of implementing a method as claimed in claim 8 for instantiating an internal data representation.
